(19) United States
(12) Patent Application Publication
(10) Pub. No.: US 2011/0199899 A1
(43) Pub. Date: Aug. 18, 2011

(54) Rate-Adaptive Bundling of Data in a Packetized Communication System

(75) Inventors: Thomas Lemaire, Acton, MA (US); Andres Guedez, Waltham, MA (US); Valery Altman, Newton, MA (US); Suhas Gupta, Waltham, MA (US)

(73) Assignee: Lime Brokerage Holding LLC, New York, NY (US)

(21) Appl. No.: 12/706,579

(22) Filed: Feb. 16, 2010

(51) Int. Cl. H04L 12/56

(52) U.S. Cl. 370/230.1

(57) ABSTRACT

Methods and apparatus minimize message latency time by dynamically controlling an amount of message bundling that occurs in a computer network application. Unbundled messages are allowed while a bottleneck resource, such as a network link, is lightly utilized, but the amount of bundling is progressively increased as the message rate increases, thereby progressively increasing resource efficiency.

### TECHNICAL FIELD

The present invention relates to packetized data communication systems and, more particularly, to such systems that dynamically vary an extent to which messages are bundled into packets, based on rates at which the messages are generated and predetermined limits related to estimated communication channel capacity.

### BACKGROUND ART

Packetized communication systems send and receive data in packets over communication links between senders and receivers. Each packet contains header, and sometimes footer, information (collectively referred herein to as “overhead”), as well as payload data. The overhead is used to store information necessary for delivering the packet, such as source and destination address information, error correcting information, and the like. The format and contents of the overhead depends on which communication protocol is used.

Messages large enough to exceed the payload capacity of a single packet are segmented, and each segment is sent in a separate packet. On the other hand, several small messages may be bundled (sometimes referred to as “aggregated” or “packetized”) together into the payload portion of a single packet. This bundling typically occurs in a transport layer (such as TCP) of a network protocol stack. For example, according to the Nagle Algorithm, a message is delayed until either: (a) enough other messages destined to travel over the same communication link have been accumulated to fill a packet or (b) an acknowledgement (ACK) of a previously transmitted packet is received.

Bundling conserves link bandwidth and reduces packet processing requirements. Bandwidth efficiency is improved by bundling, because the number of packets, and consequently the amount of overhead, carried over a network link are less than if each message were transported in its own packet. Secondary beneficial effects include fewer ACKs being carried over the link, because more payload messages can be acknowledged with a single ACK from the receiver. Furthermore, per-packet processing is reduced due to the smaller number of packets that are needed to transport a given number of messages. This can significantly reduce processor (CPU) load on the sender, the receiver and intermediate routers and switches. However, bundling usually causes some messages to wait before being transmitted over a network link.

Some contexts are sensitive to packet latency, i.e., the amount of time that elapses between when a sending application transmits a message and when a receiving application receives the message. For example, some financial applications that support high-frequency trading receive market data, such as messages containing quote and trade data, from electronic exchanges, such as the New York Stock Exchange (NYSE) and NASDAQ, and distribute this data to their clients. Some of the clients employ algorithmic trading methods to analyze this data to identify and take advantage of very short-lived market opportunities. Latencies measured in milliseconds or microseconds may influence the usefulness of the market data to the clients and the ability of the clients to place orders with the exchanges in time to exploit the identified opportunities.

Some packet latency is caused by packet and protocol processing, physical limitation of network links, etc., and is, of course, unavoidable. However, message bundling causes some messages to wait before they can be transported over a link. Bundling latency is the amount of time that elapses while a message sent by an application waits for other messages (or a bundling timeout or another event, such as receipt of an ACK associated with a previously sent packet) before the message can be placed in a packet for transportation over a link. Some users disable bundling, thereby enabling each message to be transported in a separate packet and thus avoid bundling delays. However, if its link becomes busy, a communication system that has bundling disabled is subject to severe performance degradation due to the large amount of overhead handled by the link, particularly if average message size is much less than packet payload capacity.

Prior art systems have addressed packet bundling and bundling delays. For example, Ekl (International Publication Number WO 02/27991) discloses a communication system that dynamically adjusts packet size, and therefore the amount of bundling that can occur, in response to periodically sampled system performance metrics, such as processor utilization, end-to-end packet transit time (referred to in Ekl as “delay”), jitter, bandwidth utilization, queue depth and/or wait time, or events, such as one of these performance metrics exceeding a threshold value.

Baucke, et al. (International Publication Number WO 2007/110096) discloses a system that attempts to minimize bundling delay by calculating a maximum wait time, after which a packet is transmitted, even if the packet has room for one or more additional messages. The maximum wait time is calculated based on an average arrival rate and an average size of previously sent messages, such that the maximum wait time corresponds to an average amount of time to fill a packet.

### SUMMARY OF THE INVENTION

An embodiment of the present invention provides a system for rate-adaptive control of message transmission. The messages are generated on at least one computer, which has a network port. The network port is configured to support at least two network connections. For example, an Ethernet link may connect the network port to a computer network. The Ethernet link may support several TCP network connections between the computer and several client computers. Each of the messages is to be transported over an associated one of the plurality of network connections.

The system includes at least two local message traffic shapers. Each local message traffic shaper corresponds to one of the network connections. Each local message traffic shaper is configured to limit transfer of the messages associated with its network connection to the network connection. For example, each local message traffic shaper may limit when and/or how often the messages may be dequeued and sent via a writev( ) system call to a network protocol stack, so as to be transmitted by the network protocol stack via TCP packets over the computer network. Each local message traffic shaper is configured to limit transfer of the messages, based at least in part on an aggregate rate at which the messages to be transported over all the network connections are generated. For example, each local message traffic shaper may be assigned a shaping rate, and each shaping rate may be determined according to the aggregate rate at which writev( ) calls are issued in relation to the corresponding network connection. By “generated,” we mean any action that relates to creating or forwarding a message along a message stream, such as creating the message, enqueueing the message, dequeueing the message, etc.

The system also includes a global message traffic shaper coupled to the local message traffic shapers. The global message traffic shaper is configured to limit, in aggregate, transfer of the messages over all the network connections, based at least in part on a predetermined target rate. For example, the predetermined target rate may be set to a value below a rate that would saturate a bottleneck resource or utilize the bottleneck resource at a rate that negatively influences performance of the system.

Each of the local message traffic shapers may be configured to limit the transfer of the messages to a local shape rate. The system may also include a shape rate recalculator that is configured to repeatedly automatically recalculate the local shape rate for the local message traffic shapers. The local shape rate may be recalculated to include an oversubscription amount.

Each local message traffic shaper may include a token bucket, and the global message traffic shaper may include a token bucket different than any of the local message traffic shaper token buckets. A token from the local message traffic shaper and a token from the global message traffic shaper may be required to transfer each of the messages to the corresponding network connection. In other words, before a message may be transferred to the network connection, a token may need to be consumed from the local message traffic shaper and another token may need to be consumed from the global message traffic shaper.

The messages may be held in an application layer buffer while waiting to be selected for transport over the network connection. Once selected, each message is removed from the application layer buffer for transfer to a network protocol layer for packetization. The rate at which the messages are generated may be considered to be a rate at which the messages are removed from the application layer buffer for transfer to the network protocol layer. As noted, this transfer may be implemented via a call to the writev( ) routine, or any suitable application, operating system or network protocol stack call.

Processing according to the Nagle Algorithm may be disabled, in relation to the network port. The messages may contain financial market data.

The computer may be a multiprocessor computer that includes at least two processors. A distinct subset of the local message traffic shapers may be associated with each one of the processors. For example, each processor may execute a distinct subset of the local message traffic shapers.

In such an embodiment, rather than a global message traffic shaper, there may be a per-processor message traffic shaper associated with each processor. Each per-processor message traffic shaper may be configured to limit, in aggregate, transfer of the messages generated on the associated processor. The per-processor message traffic shapers may collectively share the predetermined target rate. For example, the predetermined target rate may be (equally or unequally) divided among the per-processor message traffic shapers, so the sum of the respective shapers' target rates may add up to the global target rate.

In another multiprocessor embodiment, one global message traffic shaper is configured to limit, in aggregate, transfer of the messages generated on all the processors.

Yet another multiprocessor embodiment includes a per-processor message traffic shaper for each processor, in addition to a global message traffic shaper. Each per-processor message traffic shaper is associated with its processor. Each per-processor message traffic shaper is configured to limit, in aggregate, transfer of the messages generated on its processor. This limitation may be based at least in part on an aggregate rate at which the messages to be transported over all the network connections are generated on all of the processors. The global message traffic shaper ensures the aggregate traffic from all the processors remains below the predetermined target rate.

Each of the per-processor message traffic shapers may be configured to limit the transfer of the messages to a per-processor shape rate. The system may also include a shape rate recalculator configured to repeatedly automatically recalculate the per-processor shape rate for each per-processor message traffic shaper.

The recalculator may also be configured to automatically recalculate the per-processor shape rate, such that the per-processor shape rate is recalculated to include an oversubscription amount. In other words, the sum of the per-processor shape rates may exceed, at least at times, the overall system rate limit.

The local message traffic shapers and the global message traffic shaper may be implemented in an application layer or in a network protocol stack.

An embodiment of the present invention provides a method for rate-adaptively controlling transmission of messages. The messages may be generated on at least one computer having a network port configured to support at least two network connections. Each of the messages is to be transported over an associated one of the network connections. For each of the network connections, transfer of the messages (associated with the network connections) to the network connection is limited. This limitation may be based at least in part on an aggregate rate at which the messages to be transported over all the network connections are generated. (The meaning of “generated” is discussed above.) In addition, transfer of the messages over all the network connections may be limiting, in aggregate, based at least in part on a predetermined target rate.

A rate limit on the transfer of the messages to the network connection may be repeatedly automatically recalculated. Recalculating the rate limit may include recalculating the rate limit to include an oversubscription amount. Recalculating the rate limit may include raising the rate limit if the aggregate rate at which the messages to be transported over all the network connections are generated is less than a predetermined value, and decreasing the rate limit if the aggregate rate at which the messages to be transported over all the network connections are generated is greater than the predetermined value.

Processing according to the Nagle Algorithm may be disabled.

For each processors of a multiprocessor computer, transfer of the messages generated on the processor may be limiting, in aggregate. This limitation may include sharing the predetermined target rate among the processors. Optionally or alternatively, this limitation may include oversubscribing at least one of the processors.

Yet another embodiment of the present invention provides a method of controlling transmission of packets of financial market data through a port over a network to a set of client computers. At least one distinct buffer is associated with each of the client computers. Data from each buffer is written through the port. Writing of data from any given buffer is limited to a rate that would prevent all buffers from exceeding an aggregate target rate. The aggregate target rate may be designed to prevent saturation of hardware resources. Furthermore, the aggregate target rate may be designed so as to equitably share the target rate among buffers to the extent required by demand of the buffers.

### BRIEF DESCRIPTION OF THE DRAWINGS

The invention will be more fully understood by referring to the following Detailed Description of Specific Embodiments in conjunction with the Drawings, of which:

FIG. 1 is a schematic block diagram of an exemplary context in which embodiments of the present invention may be employed;

FIG. 2 is a more detailed schematic block diagram of a quote server of FIG. 1, according to an embodiment of the present invention;

FIG. 3 is a schematic block diagram of a feedback control mechanism, according to an embodiment of the present invention;

FIG. 4 is a more detailed schematic block diagram of a local shaper and a global shaper of FIG. 2, according to an embodiment of the present invention;

FIG. 5 (a and b) is a flow chart illustrating operation of a round-robin scheduler of FIG. 2, according to an embodiment of the present invention;

FIG. 6 is a schematic block diagram of a multiprocessor implementation, according to an embodiment of the present invention;

FIG. 7 is a schematic block diagram of a multiprocessor implementation with a shared token buck, according to another embodiment of the present invention; and

FIG. 8 is a schematic block diagram of a multiprocessor implementation with a per-processor token bucket and a shared token buck, according to yet another embodiment of the present invention.

### DETAILED DESCRIPTION OF SPECIFIC EMBODIMENTS

In accordance with embodiments of the present invention, methods and apparatus are disclosed for minimizing message latency time by dynamically controlling an amount of bundling that occurs. Unbundled messages are allowed while a bottleneck resource is lightly utilized, but the amount of bundling is progressively increased as the message rate increases, thereby progressively increasing resource efficiency. In other words, the bottleneck resource is allocated to a set of consumers, such that no consumer “wastes” the resource to the detriment of other consumers. However, while the resource is lightly utilized, a busy consumer is permitted to use more than would otherwise be the consumer's share of the resource. In particular, the consumer is permitted to use the resource in a way that is less than maximally efficient, so as to reduce latency time.

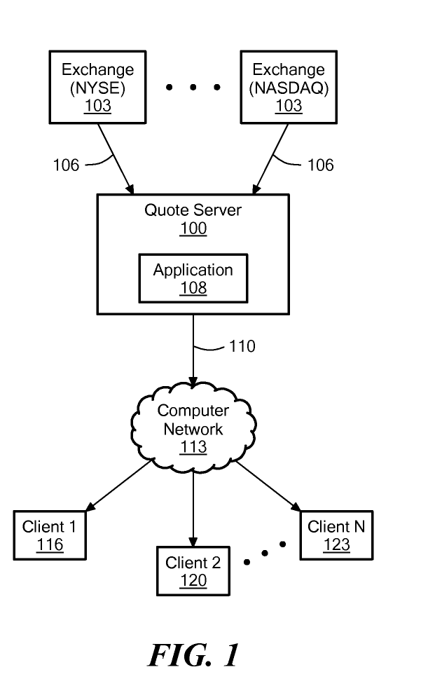

As noted, latency time can be critically important in some communication systems, such as financial applications that support high-frequency trading. FIG. 1 is a schematic block diagram of a non-limiting exemplary context in which embodiments of the present invention may be advantageously employed. A quote server 100 is coupled to one or more exchange computers 103 via network connections 106 to receive market data, such as messages containing information about offers to buy or sell securities, actual trades, etc. An application program 108 executed by the quote server 100 generates messages to distribute the received market data via a network link 110 and a network 113 to one or more client computers 116, 120 and 123. Each client computer 116-123 may receive a subscribed-to subset of the market data the quote server 100 receives from the exchanges computers 103. Thus, the application program 108 may be described as sending a separate stream of messages to each client computer 116-123, where all the streams flow through the network link 110.

Most or all of the market data messages generated by the application program 108 are small, typically much smaller than the maximum payload capacities of packets utilized in the network link 110 between the quote server 100 and the network 113. Each message generated by the quote server 100 may include information about one or more symbols (securities), and each message may be formed from information from one or more messages received from the exchange computers 103. Nevertheless, for simplicity and without loss of generality, we discuss exemplary embodiments of the present invention by referring to the messages generated within the quote server 100 as atomic units of data sent by the application program 108.

In many cases, the quote server 100 is coupled to the network 113 via a single network link 110 which, of course, has a finite bandwidth. Although not shown the quote server 100 may execute one or more additional application programs, which generate additional message streams. In addition, the quote server 100 may also be coupled to the network 113 by additional network links or to other sets of client computers via other networks and/or other network links, each with its own finite bandwidth. The descriptions provided herein apply to each such application program, message stream and network link, and the elements in FIG. 1 merely represent one example.

As noted, if the client computers 116-123 are involved in algorithmic trading, small latencies may influence the usefulness of the market data to the client computers 116-123. An operator of the quote server 100 may wish to minimize the latency of messages sent by the application program 108 to the client computers 116-123. However, a tension exists between disabling bundling to avoid message wait times associated with bundling on the one hand, and bundling as many messages as possible into each packet sent over the network link 110 so as to optimize throughput of (i.e., to get maximum benefit from the overhead carried over) the network link 110 on the other hand. As noted, disabling bundling eliminates bundling latencies; however, if the network link 110 becomes busy, performance of the network link 110 will be severely degraded, due to the large amount of overhead handled by the network link 110.

Embodiments of the present invention influence the amount of bundling in a rate-adaptive manner. The adaptation is performed per message stream semi-independently. That is, each message stream's adaptation depends primarily on the message rate of the message stream. However, the adaptation also takes into account an aggregate of all the message streams utilizing a shared resource, such as the network link 110. In some embodiments, this adaptation is performed in the application layer, i.e., not within the network protocol stack. In these embodiments, bundling by the network protocol stack is preferably disabled.

The rate at which the application program 108 generates messages destined to any one of the client computers 112-123 may vary unpredictably over time, such as in response to fluctuations in trading activity at the exchanges. Message generation by the application program 108 may be bursty. In addition, the application program's message generation rate may be different for different ones of the client computers 112-123. Furthermore, the aggregate rate at which the application program 108 generates messages that are to be transported over the network link 110 may be bursty and vary over time.

As load on any system is increased, some resource (known as a “bottleneck resource”) eventually reaches a utilization level that prevents the system from handling a further increase in the load without a dramatic decrease in system performance, even if other resources are not fully utilized. For example, in the system of FIG. 1, processing power or the network link 110 may be the bottleneck resource.

Embodiments of the present invention automatically respond to the rates (and changes in the rates) at which messages are generated by the application program 108 and destined to the various client computers 116-123 and in aggregate over the network link 110 to shape message traffic rates, so as to achieve several goals, such as: (a) preventing a bottleneck resource from reaching a utilization level that would cause an undesirable decrease in performance of the system; (b) exploiting the bottleneck resource as much as possible to decrease the latency of messages generated by the application program 108 and destined to the client computers 116-123; and (c) preventing any one or more of the message streams generated by the application program 108 from utilizing so much of the bottleneck resource as to undesirably negatively impact another one or more of the message streams.

As noted, message generation rates of the application program 108 may vary over time. Sometimes the application program 108 generates bursts of messages, interspersed with relatively quite periods. Embodiments of the present invention automatically respond to these bursts by increasing the extent to which messages are bundled, thereby increasing the efficiency of the network link 110. On the other hand, during relatively quite periods, when the network link 110 is not busy, messages are not bundled, or they are bundled to a small degree, thereby decreasing latency time. More detailed descriptions of exemplifying embodiments of the invention are now provided.

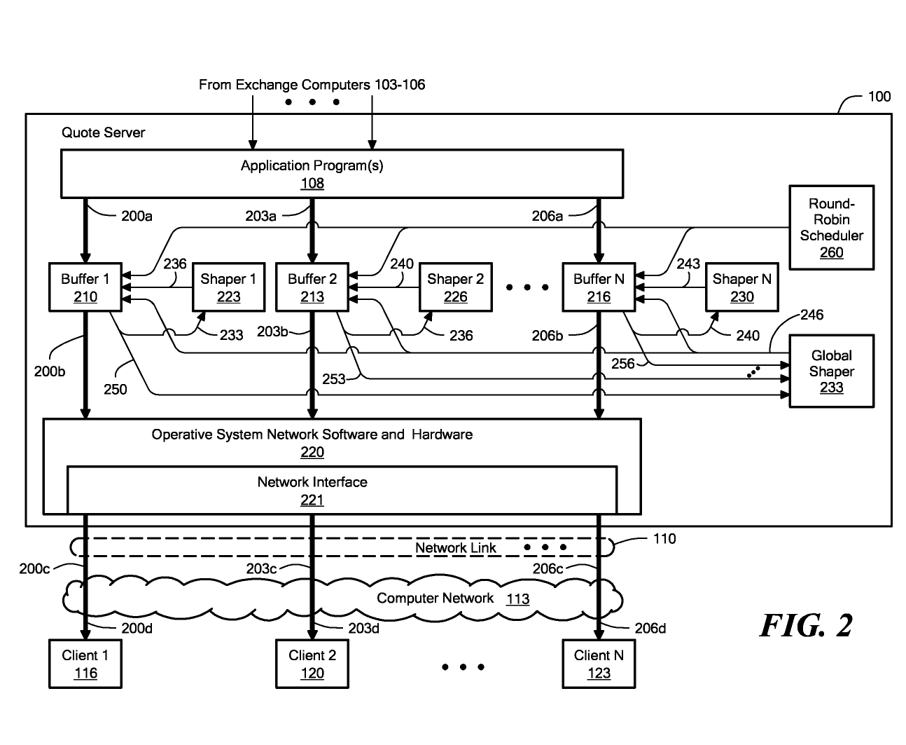

FIG. 2 is a more detailed schematic block diagram of the quote server 100 of FIG. 1. One or more application programs 108 (for simplicity referred to as a single application program) receive information from the exchange computers 103-106 and generate message streams 200, 203 and 206 to the client computers 116-123. Each message stream 200-206 includes several segments. For example, message stream 200 includes message stream segments 200a, 200b, 200c and 200d. Of course, other numbers of client computers 116-123 and other numbers of message streams 200-206 may be used. A typical quote server 100 may support hundreds of client computers 116-123 and hundreds of message streams 200-206.

Each message stream may be implemented, at least in part, as a TCP connection between a program being executed by the quote server 100 and a program (not shown) being executed by the corresponding client computer 116-123. Although not shown in FIG. 2, one client computer 116-123 or one program on one of the client computers 116-123 may be the recipient of more than one of the message streams 200-206.

A buffer 210, 213 or 216 is associated with each message stream 200-206. Any suitable software or hardware construct, such as a queue or a heap, may be used in the implementation of each buffer 210-216. As indicated by message stream segments 200a-206a, messages generated by the application program 108 are placed in the appropriate buffer 210-216 until they are ready to be transferred to operating system network software and hardware 220. Such transfers are indicated by message stream segments 200b-206b. A message transfer to the operating system network software and hardware 220 may be implemented with a call to an appropriate operating system routine, such as the Linux writev( ) routine. Other, functionally equivalent or similar, routines or system calls may be used under Linux or other operating systems. Once a message is transferred, it no longer needs to reside in the buffer 210-216, if a reliable network connection, such as a TCP connection, is used. (TCP provides reliable connections that handle any retransmissions required as a result of packets being lost or dropped along the way to the respective client computer 116-123.)

The operating system network software and hardware 220 may include an appropriate protocol stack, such as a stack that includes TCP, IP and Ethernet layers (not shown), including a hardware network interface 221, which collectively manage the network connections, including placing the messages into packets and sending the packets across the network link 110. Message segments 200c-206c represent portions of the TCP connections carried over the network link 110, which may be a Gigabit Ethernet link, for example. Message segments 200d-206d represent respective additional network links to the client computers 116-123. One or more of the message segments 200d-206d may be carried over a single shared network link, depending on how the client computers 116-123 are connected to the network 113.

### Message Traffic Shaping

As understood by those of skill in the art, “message traffic shaping” (also known as “packet shaping” or “Internet Traffic Management Practices” (ITMPs)) means the control of computer network traffic in order to optimize or guarantee performance, lower latency and/or increase usable bandwidth by delaying packets that meet certain criteria. Traffic shaping is an action on a set of packets that imposes additional delays on packets, such that the packets (or traffic involving the packets) conform to a predetermined constraint, such as limiting the volume of traffic sent into a network in a specified period of time or the maximum rate at which the traffic is sent.

As used in the present application and appended claims, a message traffic shaper may operate on, limit or control entities in addition to or different than packets, such as the messages generated by the application program 108 or the writev( ) calls to the operating system network software and hardware 220.

A message traffic shaper 223, 226 and 230 is associated with each buffer 210-216 and, therefore, with each message stream 200-206. The message traffic shapers 223-230 are referred to as “local shapers” or “per-buffer shapers.” Each local shaper 223-230 ensures that its corresponding stream 200-206 does not over utilize a resource or its share of the resource, such as the network link 110 or processing power available to execute part or all of the network protocol stack handling the writev( ) calls issued in relation to the corresponding stream 200-206.

In some embodiments, a multiprocessor computer provides a platform on which the quote server 100 is implemented. The multiple processors may be separate CPU integrated circuits, separate cores in a multicore processor integrated circuit or any other suitable circuits or hardware or software emulators. One of the processors of the multiprocessor computer may execute the application program 108, while another one of the processors executes software that implements portions of the network protocol stack and yet another processor handles interrupts generated by a network interface within the operating system network software and hardware 220. In some embodiments, two or more of the processors execute replicas or variants of the application program 108. Each of these processors, and the network link 110, may be considered a resource with a finite capacity. The local shapers 223-230 may be configured to ensure that no more than a predetermined amount of one or more resources is used for their respective message streams 200-206.

In one embodiment, each local shaper 223-230 limits when messages stored in its corresponding buffer 210-216 are transferred (as indicated by message segments 200b-206b) from the buffer 210-216 to the operating system network software and hardware 220. This limit function is indicated at 236, 240 and 243. In one embodiment, this limit function 236-243 is performed by limiting when, and therefore how often, writev( ) calls may be issued.

In addition, a global message traffic shaper 233 is associated with all the message streams 200-206 that are carried over the network link 110. The global message traffic shaper 233 ensures that, in aggregate, the streams 200-206 do not over utilize a resource, such as the network link 110 or processing power available to execute part or all of the network protocol stack handling the writev( ) calls. In one embodiment, the global message traffic shaper 233 limits the aggregate rate at which messages stored in the buffers 210-216 are transferred from the buffers 210-216 to the operating system network software and hardware 220. This limit function is indicated at 246. In one embodiment, this limit function 246 is performed by limiting when, and therefore how often, writev( ) calls may be issued. Thus, permission may be required from both a local shaper 223-230 and from the global shaper 233 to transfer one or more messages from one of the buffers 210-216 to the operating system network software and hardware 220 or to issue a writev( ) call.

In some embodiments, a round-robin scheduler 260 schedules when the transfers of messages from the buffers 210-216 occur, in conjunction with the controls 236-243 and 246 from the local shapers 233-230 and the global shaper 233, as described in more detail below.

Each local shaper 223-230 receives information, such as volume or rate, about message traffic in its respective message stream 200-206 via a feedback loop 233, 236 and 240, respectively. The global message traffic shaper 233 receives information about aggregate message traffic in all the message streams 200-206 via feedback loops 250, 253 and 256. The local shapers 233-230 and the global message traffic shaper 233 use this feedback information to inform their respective limitation functions.

For example, if one of the message streams 200-206 experiences a burst of messages after having been relatively quiet, the corresponding local shaper 223-230 may permit the message stream to proceed with little or no bundling. On the other hand, if the message stream becomes busy (i.e., the burst turns out to be a steady stream of messages), the local shaper 223-230 may progressively throttle down the rate at which the writev( ) routine may be called, thereby progressively increasing the amount of bundling to be performed on messages in this particular message stream.

In some embodiments, the system is configured such that, when the writev( ) routine is called, all of the messages in the corresponding buffer 210, 213 or 216 are transferred to the operating system network software and hardware 220. In some other embodiments, the system is configured such that as many of the messages in the buffer as will fit in the payload section of a packet are transferred to the operating system network software and hardware 220 when the writev( ) routine is called. Thus, a single call to the writev( ) routine may bundle one or more of the messages in the buffer 210, 213 or 216 and pass the bundle to the operating system network software and hardware 220 for transmission over the network link 110.

As noted, bundling is disabled in the operating system network software and hardware 220. For example, processing according to the Nagle Algorithm may be disabled in TCP by calling setsockopt and passing the TCP_NODELAY option. Consequently, the message(s) passed with a single writev( ) call may be sent over the network link 110 by the operating system network software and hardware 220, even if the message(s) do not fill the payload portion of a packet, and even if there is an outstanding unacknowledged packet. That is, one writev( ) call is likely to cause the generation of one packet. Thus, if the network link 110 is relatively lightly loaded, the message(s) should incur no bundling delay, thereby minimizing latency.

Because bundling is disabled in the operating system network software and hardware 220, the system would, absent other controls, be susceptible to severe performance degradation if the network link 110 or another bottleneck resource became very busy. However, the local rate shapers 223-230 and the global message traffic shaper 233 use their feedback mechanisms 233-240 and 250-256 to prevent the bottleneck resource from becoming critically busy. As the resource becomes progressively busier, the shapers 223-233 cause progressively more bundling to occur, thereby increasing the efficiency of the resource. However, when the resource is not busy, the shapers 223-233 allow the resource to be utilized (exploited), to the extent possible, to minimize latency. Thus, a target utilization is set for the bottleneck resource. The shapers 223-233 are configured to utilize as much of the bottleneck resource as possible, without exceeding (at least for more than a short burst) the target utilization.

Which resource is the bottleneck resource in a given system, and a target utilization for this resource, may be determined experimentally or analytically. For example, the amount of a processor resource that is used to handle one writev( ) routine call may be measured, or it may be determined by analyzing a program to count computer instructions that must be executed to handle the writev( ) routine call and associated network protocol stack software, interrupt handling routines, etc. The number of writev( ) routine calls that can be handled per unit of time by a given processor may be calculated or estimated by taking into account the number of instructions executed by the processor to complete one operation and the processor's speed. Functions performed by other processors may be similarly analyzed. The number of messages that may be sent over a network link may be calculated or estimated by dividing the network link's goodput (usable data transfer rate) by the average message size. The resource that can sustain the smallest number of operations per unit time can be determined and designated the bottleneck resource.

A target utilization may be set to the number of operations the bottleneck resource can handle without undesirably degrading system performance. For example, the target may be set to some fraction (less than one) of the maximum number of operations the bottleneck resource can handle. As known from a generalization of Little's Law, response time increases with arrival rate (or completion rate, for a balanced queuing model) almost linearly up to about 75% utilization, above which the response time increases progressively more dramatically. Thus, in many cases, setting the target to about 70-80% of the maximum number of operations the bottleneck resource can handle provides a good balance between maximizing utilization of the resource and avoiding bundling delays.

In one example, the processor that handles interrupts generated by the network interface is the bottleneck resource. In one exemplary configuration, this processor can handle interrupts resulting from up to about 400,000 writev( ) routine calls per second without undue system performance degradation. Thus, the target for this configuration may be set to about 400,000 writev( ) routine calls per second.

It should be noted that the bottleneck resource's utilization need not necessarily be directly measured. Continuing the previous example, the target is expressed in terms of the number of writev( ) routine calls per second that may be executed, not in terms of utilization of the bottleneck resource, i.e., the processor that handles the interrupts. Furthermore, a processor other than the bottleneck resource (i.e., a processor other than the processor that handles the interrupts) may execute the software that issues the calls to the writev( ) routine. Thus, the target may be imposed on operations that are performed by or on a resource other than the bottleneck resource. Furthermore, the target may be set arbitrarily.

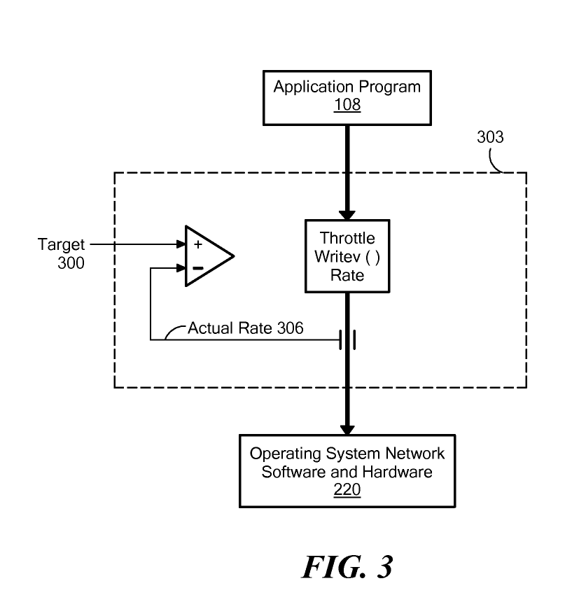

Use of a target is conceptually illustrated in FIG. 3. A predetermined target 300 is set for utilization of a bottleneck resource, and a negative feedback loop 303 prevents over-utilization of the resource. For example, the negative feedback loop 303 may throttle the rate at which writev( ) routine calls transfer messages generated by the application program 108 to the operating system network software and hardware 220. On the other hand, when the actual rate 306 of writev( ) routine calls is less than the target 300, the negative feedback loop 303 attempts to increase the writev( ) routine call rate, or it at least allows the rate to increase.

### Token Bucket Implementation

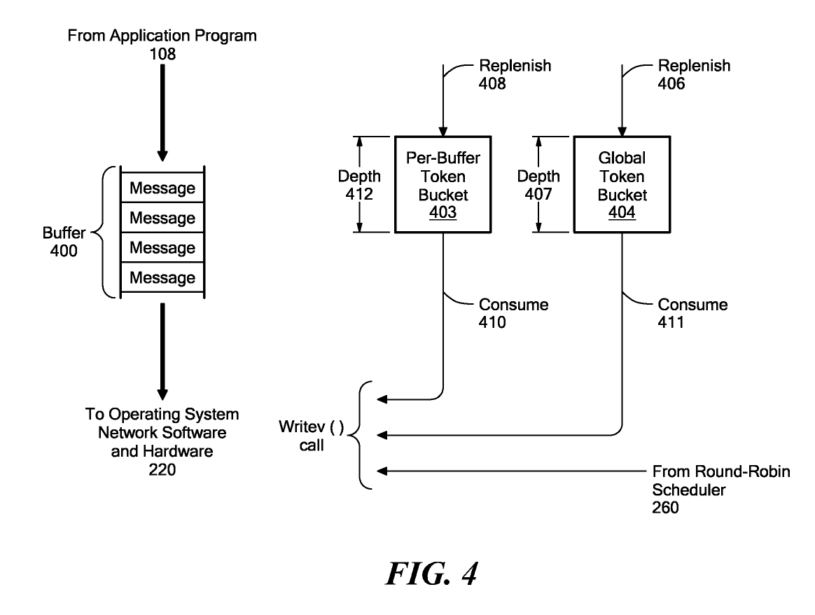

In some embodiments, each rate shaper 223-233 includes a token bucket. A token bucket may be implemented using an up/down counter. A portion of one of the message streams 200-206 is illustrated schematically in FIG. 4 to show operation of such an embodiment. (For descriptive purposes, assume FIG. 4 shows a portion of message stream 200.) As noted, the application program 108 generates messages, which are held in a buffer 210 (FIG. 2) until they can be transferred to the operating system network software and hardware 220 via writev( ) routine calls. Such a buffer 400 is shown in FIG. 4, implemented as a queue. The buffer's associated local shaper 223 (FIG. 2) includes a per-buffer token bucket 403. In addition, the global shaper 233 (FIG. 2) includes a global token bucket 404. One token from the per-buffer token bucket 403 and one token from the global token bucket 404 are required to issue a writev( ) routine call. In addition, calls to the writev( ) routine are scheduled by the round-robin scheduler 260, as discussed in more detail below.

Tokens are added to the global token bucket 404 (i.e., replenished 406) at a rate consistent with a desired shape of the aggregate network traffic on the network link 110 (FIG. 2). In one embodiment, the replenishment rate 406 equals the maximum sustained aggregate rate at which writev( ) routine calls are to be executed for all message streams 200-206 (FIG. 2) that share the bottleneck resource, such as the network link 110. Continuing the previous example, tokens may be added to the global token bucket 404 at a rate of about 400,000 tokens per second. Tokens may be added at small, equal-time intervals or occasionally, as described in more detail below.

The global token bucket 404 has a limit (depth 407) on the number of tokens it can hold. If the global token bucket 404 becomes full, no further tokens are added 406 to it until one or more tokens are consumed 411. The global token bucket's 404 depth 407 is discussed in more detail below.

Similarly, tokens are added to the per-buffer token bucket 403 (i.e., replenished 408) at a rate consistent with a desired shape of network traffic resulting from the message stream 200. As with the global token bucket 404, the per-buffer token bucket 403 has a limit (depth 412) on the number of tokens that it can hold.

In one embodiment, the replenishment rate 408 for the per-buffer token bucket 403 equals the maximum sustained rate at which writev( ) routine calls should be executed for the corresponding message stream 200. The per-buffer token replenishment rate 408 may be simply a fraction of the target aggregate rate for the network link 110, i.e., a fraction of the global token bucket's 404 replenishment rate 406. However, in another embodiment, we include an “Oversubscription factor,” as shown in Equation (1), in the replenishment rate 408. In equation (1), a “Target writev( ) rate” may be the global token bucket's 404 replenishment rate 406, and a “Number of connections” may be the number of message streams 200-206 (FIG. 2) sharing the network link 110.

$$Per \text{-} buffer token replenishment rate = \frac{Target writev ( ) rate}{Number of connections} * Oversubscription factor \qquad ( 1 )$$

Absent the “Oversubscription factor,” all the local shapers 223-230 (FIG. 2) would receive equal shares of the bottleneck resource. However, if one or more of the other message streams 200-206 (FIG. 2) is heavily loaded while other of the message streams 200-206 are lightly loaded, such an equal distribution of the bottleneck resource's capabilities could “waste” some of the capabilities. That is, the lightly loaded message streams might not use all the tokens allocated to them, while the busy message streams may be starved, or at least throttled, of tokens. Thus, at least while the aggregate message rate is low, an oversubscription factor greater than 1 may be applied, essentially over-committing the bottleneck resource. This over commitment enables one or more of the message streams 200-206 to respond to sustained high levels of activity by using disproportionately large fractions of the bottleneck resource. The global token bucket ensures that the aggregate rate does not exceed the target rate (at least not for an extended period of time), in case too many of the message streams 200-206 try to take advantage of their over-allocations of tokens.

In one embodiment, the oversubscription factor is determined from a table, based on the aggregate rate at which writev( ) routine calls are issued by all the message streams 200-206. An example of one such table is illustrated in Table 1.

TABLE 1

| Aggregate Rate | Oversubscription Factor |
|---|---|
| 100k writev( ) calls per second | 10.0 |
| 200k | 4.0 |
| 300k | 2.0 |
| 400k | 1.5 |
| 500k | 0.9 |

The values in Table 1 are presented merely as one example. Other table values may, of course, be selected based on the amounts of resources required to perform a function, processor speeds, network link capacity, degree to utilization desired for a bottleneck resource, etc. Furthermore, the table may include more or fewer rows, depending on the granularity with which the oversubscription factor is to be administered.

When the aggregate write rate is low, for example less than about 100 writev( ) calls per second, the oversubscription factor may be large, for example about 10, whereas when the aggregate write rate is high, for example more than about 300 writev( ) calls per second, the oversubscription factor may be less, for example about 2, and when the aggregate write rate exceeds the desired value, the oversubscription rate may be less than 1.

Although a table of oversubscription factors may be used, in another embodiment we prefer to initialize each per-buffer token replenishment rate to an equal fraction of the global token bucket's 404 replenishment rate 406. We prefer to set the initial per-buffer token replenishment rate to the global token bucket's 404 replenishment rate 406 divided by a number smaller than the number of message streams 200-206, thereby initially oversubscribing each of the local shapers 223-230. We then periodically or occasionally adjust each per-buffer token replenishment rate by a percentage of the then-current value of the per-buffer token replenishment rate, as shown in Equation (2). This adjustment may be performed by the round-robin scheduler 260, as described below.

Per-buffer token replenishment rate=Per-buffer token replenishment rate±Per-buffer token replenishment rate*Step rate (2)

The “Step rate” is the amount by which the per-buffer token replenishment rate is adjusted. This may be any suitable adjustment amount. In one embodiment, we use about 0.01. Thus, the replenishment rate increases or decreases in steps of about 1%. However, larger or smaller values may be used, depending on how rapidly the replenishment rate is to change. For example, if large or small changes in the rate of writev( ) routine calls are expected over time, larger or smaller step rate values may be used, respectively.

If the aggregate rate of writev( ) calls is less than the target aggregate rate, the per-buffer token replenishment rate may be increased, whereas if aggregate rate of writev( ) calls exceeds or equals (within a predetermined range of) the aggregate target, the per-buffer token replenishment rate may be decreased.

Optionally, if the aggregate rate of writev( ) calls is within a predetermined range of the aggregate target rate, the per-buffer token replenishment rate may remain unchanged. However, in the context of high-frequency trading, each message stream's writev( ) routine call rate and the aggregate writev( ) call rate are expected to vary almost continuously. Thus, there may be no steady-state optimum value for the per-buffer token replenishment rate, and a system that always either increases or decreases the per-buffer token replenishment rate may be sufficient.

Optionally, the step rate may itself be varied, depending on the aggregate writev( ) routine call rate, so as to more quickly adapt to changes in the aggregate rate. In one embodiment, the step rate decreases as the actual aggregate writev( ) routine call rate approaches the target aggregate rate, and the step rate increases as the difference between the actual aggregate rate and the target aggregate rate becomes larger.

As noted, the per-buffer token bucket 403 (FIG. 4) and the global token bucket 404 have depths 412 and 407, respectively, which limit how many tokens the buckets can hold. Tokens are not added to a full bucket; instead, the tokens that would have been added are discarded. The per-buffer token bucket 403 depth 412 enables the corresponding message stream 200 to send a burst of messages without requiring the messages to be bundled. The burst size is largely limited to the number of tokens currently in the per-buffer token bucket 403. However, if a burst turns out to be a steady stream of messages, as soon as the per-buffer token bucket 403 is depleted, the message stream begins bundling messages.

Essentially, the per-buffer token bucket 403 enables the system to determine if the corresponding message stream 200 is in a burst, without storing historical message rate data. If the per-buffer token bucket 403 is relatively full, the message stream 200 is not likely to be currently experiencing a burst. However, if the per-buffer token bucket 403 is empty or nearly empty, the message stream 200 is experiencing a burst or a sustained high traffic period.

The depths of the per-buffer token buckets need not be fixed. In some embodiments, the depths of the per-buffer tokens are adjusted, based on the aggregate rate of calls to the writev( ) routine, as described below.

### Scheduler

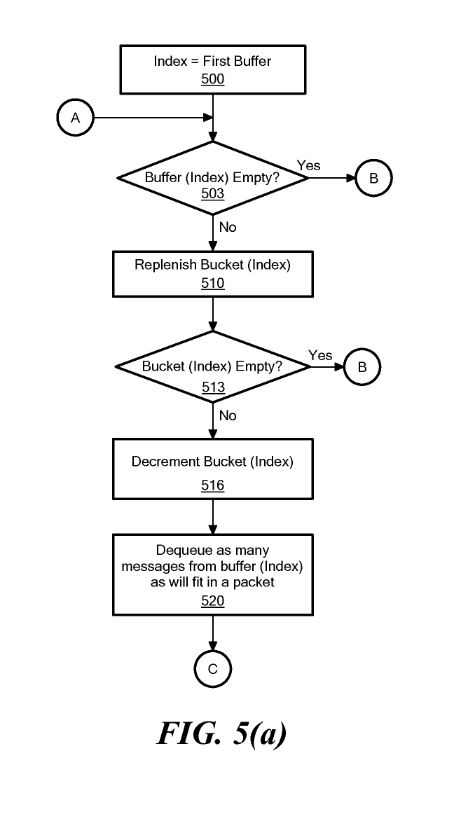

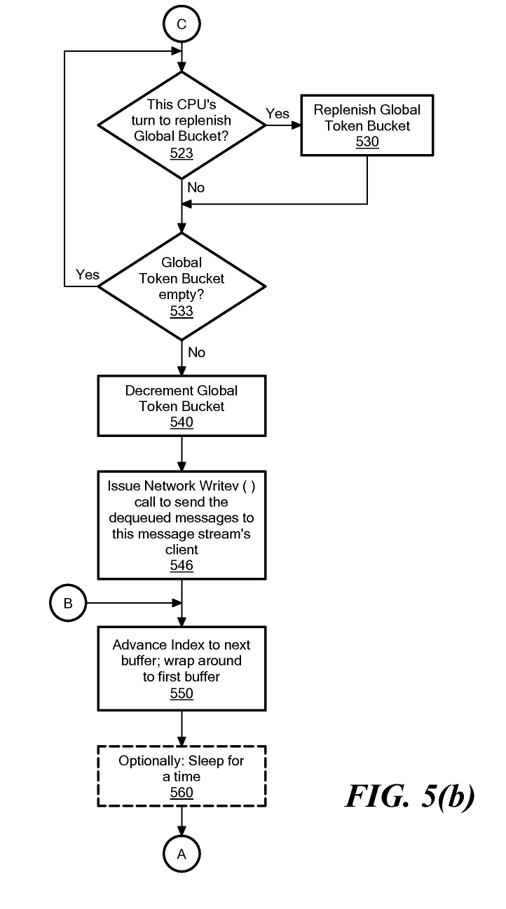

As noted with reference to FIG. 2, a round-robin scheduler 260 schedules transfers of messages from the buffers 210-216 to the operating system network software and hardware 220. FIG. 5 is a flowchart that illustrates operation of one embodiment of the round-robin scheduler 260. The round-robin scheduler 260 cycles through message streams 200-206 (FIG. 2), i.e., through the message buffers 210-216. For each non-empty message buffer 210-216, if the corresponding per-buffer token bucket (ex., per-buffer token bucket 403, FIG. 4) has a token, and a token is available in the global token bucket 404, the round-robin scheduler 260 permits a writev( ) routine call to be issued to transfer messages in the message buffer to the operating system network software and hardware 220. As noted, the transferred messages are likely to be transmitted together in a single packet. The round-robin scheduler 260 also replenishes the per-buffer token buckets. In addition, the round-robin scheduler 260 replenishes the global token bucket, although this task may be shared with other round-robin schedulers being executed by other processors on a multi-processor system, as described in more detail below.

As shown in FIG. 5, at 500, the round-robin scheduler 260 begins by setting an index to point to the first buffer 210, and then the scheduler 260 enters a loop. Each time through the loop, the round-robin scheduler 260 processes one of the message buffers 210-216, i.e., one of the message streams 200-206. At 503, if the buffer pointed to by the index is empty, the scheduler skips this buffer. On the other hand, if the buffer is not empty, control passes to 510, where the per-buffer token bucket is replenished.

Equations (1) and (2) provide two possible ways of calculating a per-buffer token replenishment rate. Other per-buffer token replenishment algorithms may, of course, be used. Operation 510 may not (and need not) be performed at periodic intervals. Thus, whenever operation 510 is performed, a number of tokens to be added to the per-buffer token bucket is calculated, based on the appropriate replenishment rate and on the amount of time that has elapsed since the last time the per-buffer token bucket was replenished. Whole numbers of tokens (or no tokens at all) are added to the token bucket. Thus, the result of any calculation of a number of tokens to be added is truncated (or, in some embodiments, rounded) to arrive at the number of tokens to be added to the token bucket. Note that not every execution of operation 510 necessarily adds any tokens. If the calculated number of tokens to add is less than 1 (or, in some embodiments, less than ½), no token is added. As previously noted, excess tokens, that is, tokens in excess of the token bucket depth 412 (FIG. 4), are discarded.

As a consequence of calculating the per-buffer token replenishment rate, the depth of the token bucket may change. In a sense, the tokens in any one per-buffer token bucket represent a possible burst of packets that may be generated in relation to the corresponding message stream 200-206 (FIG. 2), if all the tokens were to be consumed within a short period of time. We prefer to limit the duration of a packet burst that may be sent in relation to any single message stream 200-206 to about 5 milliseconds, unless the bottleneck resource is not busy. (Other maximum burst durations may, of course, be used.) Thus, the depth of the per-buffer token bucket is calculated by multiplying the per-buffer token replenishment rate by 5 milliseconds (or some other maximum burst duration).

One reason for maintaining depths of per-buffer token buckets relates to a buildup of tokens that can occur during quiet periods. For example, if all the message streams 200-206 experience only light traffic for a long period of time, all the per-buffer token buckets may fill with tokens. Then, if message traffic suddenly increases in several or all of the message streams 200-206, such as due to market activity in response to a major announcement by the Board of Governors of the Federal Reserve System, many or all of the message streams 200-206 may attempt to “cash in” on their accumulated tokens, resulting in an overload being placed on the bottleneck resource. Thus, some embodiments of the system relatively quickly react to an increase in the aggregate writev( ) routine call rate by reducing the per-buffer token bucket replenishment rate, which in turn causes a reduction in the per-buffer token bucket depths, thereby forcing the message streams to forfeit some of their accumulated tokens.

The above-described token replenishment mechanisms distribute tokens among the per-buffer token buckets equally. However, in some other embodiments, the per-buffer token replenishment is asymmetric. That is, the target aggregate rate of writev( ) routine calls may be unequally divided among the buffers 210-230 (FIG. 2), such as depending on a quality of service (QoS) intended to be provided to the various message streams 200-206. For example, different ones of the client computers 116-123 may receive different contracted-for qualities of service.

At 513, if the per-buffer token bucket is empty, the scheduler skips this buffer. It should be noted that operation 510 may not have added any tokens to the per-buffer token bucket, such as if the calculated number of tokens to add was less than 1. Thus, although operation 510 occurs before the decision 513, the per-buffer token bucket may be empty. This may be the case if, for example, the associated message stream is busy and has been busy for some time, thereby depleting its per-buffer token bucket, and the aggregate rate of writev( ) routine calls is high, thereby reducing the replenishment rate for the per-buffer token bucket.

On the other hand, if a per-buffer token is available at 513, control passes to 516, where the number of tokens in the per-buffer token bucket is decremented, i.e., a per-buffer token is consumed. At 520, as many messages as will fit in a packet are dequeued from the message queue.

As noted, the scheduler 260 replenishes the global token bucket 404 (FIG. 4). Also as noted, some embodiments employ multiprocessor computers, and in some such embodiments, each of two or more of the processors executes a replica or variant of the application program 108 (FIGS. 1 and 2). In cases where the message buffers 210-216 are serviced by two or more processors, each such processor may execute a copy of the scheduler 260. However, in some embodiments, one global token bucket 404 (FIG. 4) services all the message buffers 210-216 whose messages are to be transmitted over a single network link 110, regardless of how many processors service the message buffers 210-216. Replenishment of the global token bucket 404 may be performed by any one processor (within the context of the scheduler 260 being executed by that processor or within a different context), or the task may be shared by two or more processors. Here, we describe sharing the replenishment task among all the schedulers 260.

The global bucket replenishment task may be divided between or among all the schedulers 260, such as on a rotating basis. At 523, if it is this processor's turn to replenish the global token bucket, control passes to 530, where the global token bucket is replenished.

Possible ways of calculating a rate at which tokens are added to the global token bucket were described above. As with the per-buffer token buckets, whenever operation 530 is performed, a whole number (possibly zero) of tokens to be added to the global token bucket is calculated, based on the appropriate replenishment rate and on the amount of time that has elapsed since the last time the global token bucket was replenished. As previously noted, excess tokens, that is, tokens in excess of the global token bucket depth 407 (FIG. 4), are discarded.

Before issuing a call to the writev( ) routine, an attempt is made to consume a global token. At 533, if no global token is available, control passes back to 523, forming a loop. If it is this scheduler's turn to replenish the global token bucket, eventually an execution of operation 530 will add a token to the global token bucket. (Until the calculation performed by operation 530 yields a number larger than 1, no tokens are added.) On the other hand, if it is another scheduler's turn to replenish the global token bucket, the other scheduler, being executed by another processor, will eventually replenish the global token bucket. At 540, the number of global tokens is decremented, and at 546 the writev( ) routine is called with the dequeued messages.

At 550, the index is advanced to the next buffer. If the index is advanced beyond the last buffer 216 (FIG. 2), the index is returned to the first buffer 210. Optionally, at 560, the scheduler 260 sleeps for a time. Control then returns to 503, so the next buffer may be processed.

### Multiprocessor Implementations

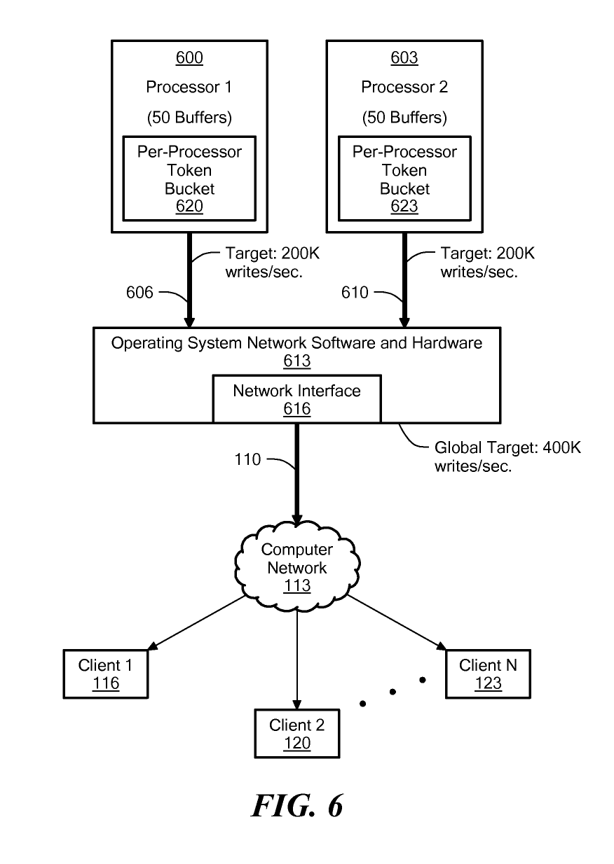

As noted, in some embodiments multiprocessor computers may be used, and multiple instances of the application program 108 (FIGS. 1 and 2) may be executed concurrently by separate processors. FIG. 6 is a schematic block diagram of one such embodiment, which includes two processors 600 and 603 but, of course, other numbers of processors can be used. The message streams 200-206 (FIG. 2) may be distributed between or among the processors 600-603. In the example shown in FIG. 6, each processor handles 50 message streams, but other numbers of message streams per processor may be used. Each message stream has an associated message buffer and an associated per-buffer token bucket, as described above in relation to the single processor case.

Each processor 600, 603 generates a processor-aggregate message stream 606 and 610, respectively. One set of operating system network software and hardware 613 processes both processor-aggregate message streams 606-610. The operating system network software and hardware 613 are preferably handled by a third processor.

The network interface 616 in the operating system network software and hardware 613 has the same or similar limitations as the network interface in a single processor system. Thus, a target is set for a system-wide aggregate rate at which writev( ) routine calls may be made (400,000 writes per second, in the example of FIG. 6). Each processor 600-603 is allocated a portion of the target processor-aggregate write rate (200,000 writes per second, in the example of FIG. 6). The allocations need not be equal among the processors 600-603. However, the sum of the processor-aggregate write rates may not exceed the system-wide target.

In the embodiment shown in FIG. 6, each processor maintains its own metrics, such as its writev( ) routine call rate. Each processor's metrics are accessible by the other processor, such as via shared memory. In addition, each processor maintains a per-processor token bucket 620 and 623, respectively. These per-processor token buckets 620-623 operate the same way the global token bucket 404 (FIG. 4) operates in a single processor system, except decisions and calculations related to when and how many tokens are to be added to a per-processor token bucket or to a per-buffer token bucket sum the writev( ) routine call rates for all the processors and compare the system-wide write rate to the system-wide target.

Preferably, only one crediting operation replenishes all the per-processor token buckets. This may be a scheduler or another similar routine. The crediting operation calculates the aggregate number of global tokens that should be distributed among the processors 600-603, and then the crediting operation distributes the tokens among the per-processor token buckets 620-623. When a per-processor token bucket 620 or 623 is replenished, any tokens that can not be added to the token bucket due to that processor's per-processor token bucket's depth limit are distributed among the remaining per-processor token buckets (to the extents that the remaining per-processor token buckets are not already full), rather than being discarded. Multiple passes may per performed to distribute the tokens among the per-processor token buckets 620-623.

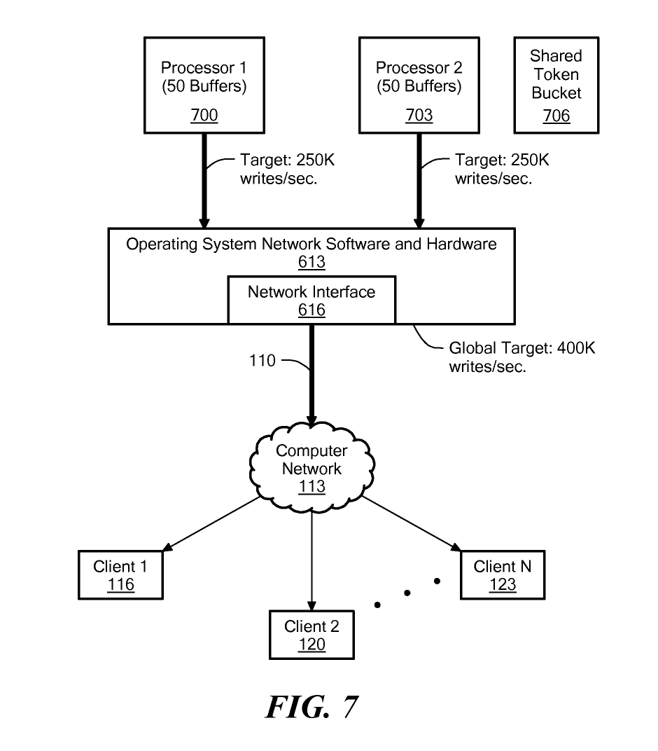

FIG. 7 is a schematic block diagram of another multiprocessor embodiment, which is similar to the embodiment of FIG. 6, except the processors 700 and 703 do not maintain separate per-processor token buckets. Instead, one shared token bucket 706 is used by all the processors 700-703. The shared token bucket 706 may be accessed via shared memory or any other suitable sharing mechanism. When a scheduler executed by either processor 700, 703 needs a global token (i.e., operations 533 and 540, FIG. 5), the shared token bucket 706 is accessed. As noted above, the schedulers may share the task of replenishing the shared token bucket 706. However, preferably, a single mechanism replenishes the shared token bucket 706.

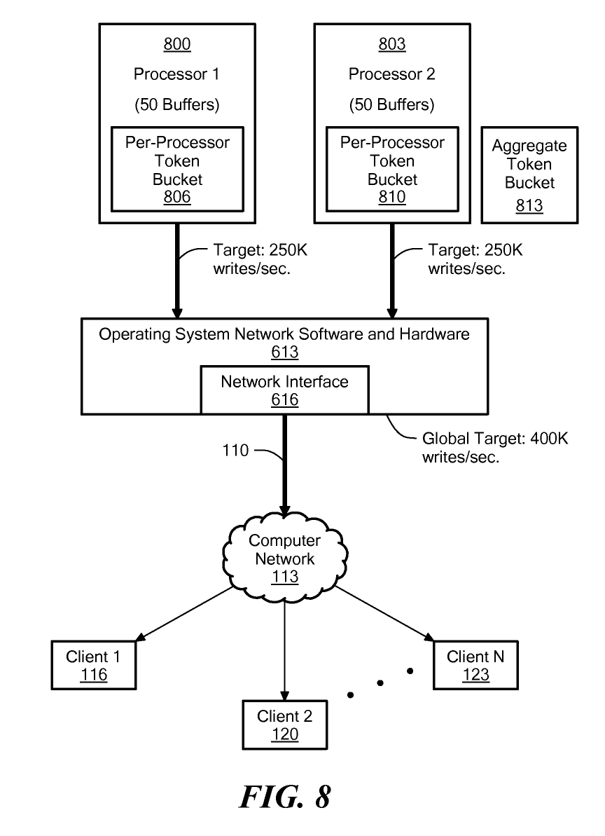

FIG. 8 is a schematic block diagram of yet another multiprocessor embodiment. This embodiment includes three levels of token buckets, whereas the previously described embodiments include two levels of token buckets. In the embodiment of FIG. 8, each processor 800 and 803 maintains per-buffer token buckets, which operate as described in the single processor case. Each processor also maintains a respective per-processor token bucket 806 and 810. In addition, an aggregate token bucket 813 is maintained.

The per-processor token buckets 806-810 are used to shape the aggregate message traffic generated by their respective processors. The aggregate token bucket 813 is used to shape the message traffic from the entire system, i.e., from all the processors 800-803. The previously described scheduler 260 may be modified to require three tokens before allowing a call to the writev( ) routine: one per-buffer token, one per-processor token from the appropriate per-processor token bucket 806-810 and one aggregate token from the aggregate token bucket 813.

The scheduler may also be modified to replenish the per-processor token buckets 806-810, by extension to the descriptions given above for the single processor case. That is, each per-processor token bucket 806-810 may initially have a replenishment rate that is a (equal or unequal) fraction of the replenishment rate for the aggregate token bucket 813 (400,000 tokens per second, in the example of FIG. 8). For example, each per-processor token bucket 806-810 replenishment rate may be one-half of the aggregate token bucket 813 replenishment rate. We prefer to initially oversubscribe each per-processor token bucket 806-810. The per-processor token bucket 806-810 replenishment rates may then be independently adjusted up or down (such as in 1% steps, as described above), depending on the actual aggregate rate at which writev( ) routine calls are issued on the respective processors 800-803.

The per-processor token bucket 806-810 replenishment rates may add up to more than the aggregate token bucket 813 replenishment rate, using the same logic that allows a single processor's per-buffer token bucket replenishment rates to add up to more than the global (processor) token bucket replenishment rate. That is, the per-processor shapers 806-810 may, in total, oversubscribe the aggregate 813 shaping rate. This permits one or more, but not all, of the processors 800-803 to use more than their “fair share” of the bottleneck resource, as long as the bottleneck resource is not utilized to an extent defined by its aggregate target rate. As noted, the aggregate token bucket 813 ensures the bottleneck resource is not over-utilized.

### OTHER EMBODIMENTS

Although embodiments have been described as using TCP packets, other embodiments may use other types of network packets. For example, UDP provides network connections without the guarantee of reliable delivery provided by TCP. UDP is often used in applications that require low latency. Embodiments of the present invention may use UDP as a transport mechanism, which may provide advantages over using UDP without benefit of the present invention. For example, if an application that uses TCP overloads a network link, packets may be delayed and/or retransmitted by TCP, resulting in high latency. However, the packets are reliably delivered. In contrast, if an application that uses UDP overloads a network link, the result is typically high latency and undelivered packets.

Employing an embodiment of the present invention in an application that utilizes UDP transport can prevent or reduce the likelihood of overloading a network link, because the message streams are shaped, therefore preventing or reducing the likelihood of undelivered packets. At the same time, an application that utilizes UDP transport and an embodiment of the present invention retains the benefits of low latency provided by UDP transport when the network is not heavily loaded.

Embodiments of the present invention have been described as being implemented in the application layer of a system. However, other embodiments may be implemented in another layer, such as the layer where TCP or UDP packetization is performed or where the decision when to transmit a packet is performed (i.e., in the layer where the Nagle Algorithm is implemented). Features provided by such an embodiment may be selectively enabled or disabled, such as by a call to setsockopt, passing appropriate parameters. For example, traffic shaping may be enabled for all network connections or only for designated network connections.

In accordance with an exemplary embodiment, systems and methods are provided for dynamically controlling an amount of bundling that occurs in a network communication application. While specific values chosen for these embodiments are recited, it is to be understood that, within the scope of the invention, the values of all of parameters may vary over wide ranges to suit different applications.

A systems for dynamically controlling an amount of bundling that occurs in a network communication has been described as including a processor controlled by instructions stored in a memory. The memory may be random access memory (RAM), read-only memory (ROM), flash memory or any other memory, or combination thereof, suitable for storing control software or other instructions and data. Some of the functions performed by the system have been described with reference to flowcharts and/or block diagrams. Those skilled in the art should readily appreciate that functions, operations, decisions, etc. of all or a portion of each block, or a combination of blocks, of the flowcharts or block diagrams may be implemented as computer program instructions, software, hardware, firmware or combinations thereof. Those skilled in the art should also readily appreciate that instructions or programs defining the functions of the present invention may be delivered to a processor in many forms, including, but not limited to, information permanently stored on non-writable storage media (e.g. read-only memory devices within a computer, such as ROM, or devices readable by a computer I/O attachment, such as CD-ROM or DVD disks), information alterably stored on writable storage media (e.g. floppy disks, removable flash memory and hard drives) or information conveyed to a computer through communication media, including wired or wireless computer networks. In addition, while the invention may be embodied in software, the functions necessary to implement the invention may optionally or alternatively be embodied in part or in whole using firmware and/or hardware components, such as combinatorial logic, Application Specific Integrated Circuits (ASICs), Field-Programmable Gate Arrays (FPGAs) or other hardware or some combination of hardware, software and/or firmware components.

While the invention is described through the above-described exemplary embodiments, it will be understood by those of ordinary skill in the art that modifications to, and variations of, the illustrated embodiments may be made without departing from the inventive concepts disclosed herein. For example, although some aspects of the system have been described with reference to a flowchart, those skilled in the art should readily appreciate that functions, operations, decisions, etc. of all or a portion of each block, or a combination of blocks, of the flowchart may be combined, separated into separate operations or performed in other orders. Furthermore, disclosed aspects, or portions of these aspects, may be combined in ways not listed above. Accordingly, the invention should not be viewed as being limited to the disclosed embodiment(s).

What is claimed is:

1. A system for rate-adaptive control of transmission of messages generated on at least one computer having a network port configured to support a plurality of network connections, wherein each of the messages is to be transported over an associated one of the plurality of network connections, the system comprising:
(a) a plurality of local message traffic shapers, each local message traffic shaper:
corresponding to one of the plurality of network connections (“the network connection”); and
configured to limit transfer of the messages associated with the network connection to the network connection, based at least in part on an aggregate rate at which the messages to be transported over all the network connections are generated; and
(b) a global message traffic shaper coupled to the plurality of local message traffic shapers and configured to limit, in aggregate, transfer of the messages over all the network connections, based at least in part on a predetermined target rate.

2. A system according to claim 1, wherein:
each of the plurality of local message traffic shapers is configured to limit the transfer of the messages to a local shape rate; the system further comprising:
a shape rate recalculator configured to repeatedly automatically recalculate the local shape rate for the plurality of local message traffic shapers.

3. A system according to claim 2, wherein the recalculator is further configured to automatically recalculate the local shape rate, such that the local shape rate is recalculated to include an oversubscription amount.

4. A system according to claim 1, wherein:
each local message traffic shaper comprises a token bucket;
the global message traffic shaper comprises a token bucket different than any of the local message traffic shaper token buckets; and
a token from the local message traffic shaper and a token from the global message traffic shaper are required prior to transferring each of the messages to the corresponding network connection.

5. A system according to claim 1, wherein the rate at which the messages, to be transported over the corresponding network connection, are generated comprises a rate at which the messages are removed from an application layer buffer for transfer to a network protocol layer for packetization.

6. A system according to claim 5, wherein processing according to the Nagle Algorithm is disabled, in relation to the network port.

7. A system according to claim 1, wherein the messages contain financial market data.

8. A system according to claim 1, wherein:
the computer comprises a multiprocessor computer including a plurality of processors;
a distinct subset of the plurality of local message traffic shapers is associated with each one of the plurality of processors; and
the global message traffic shaper is associated with one of the plurality of processors, the system further comprising an additional global message traffic shaper associated with each other one of the plurality of processors; wherein:
each global message traffic shaper is configured to limit, in aggregate, transfer of the messages generated on the associated processor; and
the global message traffic shapers collectively share the predetermined target rate.

9. A system according to claim 1, wherein:
the computer comprises a multiprocessor computer including a plurality of processors;
a distinct subset of the plurality of local message traffic shapers is associated with each one of the plurality of processors; and
the global message traffic shaper is configured to limit, in aggregate, transfer of the messages generated on the plurality of processors.

10. A system according to claim 1, wherein:
the computer comprises a multiprocessor computer including a plurality of processors;
a distinct subset of the plurality of local message traffic shapers is associated with each one of the plurality of processors; the system further comprising:
a plurality of per-processor message traffic shapers, each per-processor message traffic shaper:
associated with one of the plurality of processors; and
configured to limit, in aggregate for the associated processor, transfer of the messages generated on the associated processor, based at least in part on an aggregate rate at which the messages to be transported over all the network connections are generated on the plurality of processors.

11. A system according to claim 10, wherein:
each of the a plurality of per-processor message traffic shapers is configured to limit the transfer of the messages to a per-processor shape rate; the system further comprising:
a shape rate recalculator configured to repeatedly automatically recalculate the per-processor shape rate for each of the a plurality of per-processor message traffic shapers.

12. A system according to claim 11, wherein the recalculator is further configured to automatically recalculate the per-processor shape rate, such that the per-processor shape rate is recalculated to include an oversubscription amount.

13. A system according to claim 1, wherein the plurality of local message traffic shapers and the global message traffic shaper are implemented in an application layer.

14. A system according to claim 1, wherein the plurality of local message traffic shapers and the global message traffic shaper are implemented in a network protocol stack.

15. A method for rate-adaptively controlling transmission of messages generated on at least one computer having a network port configured to support a plurality of network connections, wherein each of the messages is to be transported over an associated one of the plurality of network connections, the method comprising:
for each of the plurality of network connections, limiting transfer of the messages associated with the network connections to the network connection, based at least in part on an aggregate rate at which the messages to be transported over all the network connections are generated; and
limiting, in aggregate, transfer of the messages over all the network connections, based at least in part on a predetermined target rate.

16. A method according to claim 15, further comprising repeatedly automatically recalculating a rate limit on the transfer of the messages to the network connection.

17. A method according to claim 16, wherein recalculating the rate limit comprises recalculating the rate limit to include an oversubscription amount.

18. A method according to claim 16, wherein recalculating the rate limit comprises raising the rate limit if the aggregate rate at which the messages to be transported over all the network connections are generated is less than a predetermined value, and decreasing the rate limit if the aggregate rate at which the messages to be transported over all the network connections are generated is greater than the predetermined value.

19. A method according to claim 15, further comprising disabling processing according to a Nagle Algorithm.

20. A method according to claim 15, further comprising:
for each of a plurality of processors of a multiprocessor computer, limiting, in aggregate, transfer of the messages generated on the processor.

21. A method according to claim 20, wherein limiting, in aggregate, the transfer of the messages generated on the processor comprises sharing the predetermined target rate among the plurality of processors.

22. A method according to claim 20, wherein limiting, in aggregate, the transfer of the messages generated on the processor comprises oversubscribing at least one of the processors.

23. A method of controlling transmission of packets of financial market data through a port over a network to a set of client computers, the method comprising:
associating at least one distinct buffer with each of the client computers;
writing data from each buffer through the port, while limiting writing of data from any given buffer to a rate that would prevent all buffers from exceeding an aggregate target rate designed to prevent saturation of hardware resources and that equitably shares the target rate among buffers to the extent required by demand of the buffers.
